(19) United States
(12) Patent Application Publication
(10) Pub. No.: US 2003/0186129 A1
(43) Pub. Date: Oct. 2, 2003

(54) Hydrophilized separator material

(75) Inventors: Christian Trautmann, Fuerth (DE); Peter Kritzer, Forst (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/397,991

(22) Filed: Mar. 26, 2003

(30) Foreign Application Priority Data
Mar. 26, 2002 (DE) DE 102 13 449.9

(51) Int. Cl. H01M 2/16

(52) U.S. Cl. 429/250; 429/254

(57) ABSTRACT

A hydrophilized separator material includes a plurality of synthetic fibers impregnated with 0.01 to 10 g/m² of at least one of an alkali hydroxide and an alkali carbonate. In addition, a method for manufacturing such a separator material as well as an alkaline cell or battery containing such a separator material.

This application claims priority to German Patent Application DE 102 13 449.9, filed Mar. 26, 2002, which is incorporated by reference herein.

### BACKGROUND

The subject matter of the present invention relates to flat, flexible, electrolyte-resistant separator materials; which can be quickly and completely wetted with an aqueous alkaline electrolyte. Moreover, the present invention relates to methods for manufacturing such a separator material and alkaline batteries or cells containing such separators.

Separators are used in electrochemical energy storage devices to prevent contact of positive and negative electrodes and, consequently, unwanted current flow between the electrodes, however, without significantly hindering the passage of ions of the electrolyte liquid. In this context, the separator materials used must have the following properties:

resistance to the electrolyte (usually concentrated potassium hydroxide solution or sodium hydroxide solution) at temperatures up to 70° C.,

resistance to oxidation,

low resistance to the passage of ions,

high resistance to the passage of electrons,

permanent wettability by the electrolyte

high initial wettability by the electrolyte,

high storage capacity for the electrolyte,

retention capacity for particles coming off the electrodes,

small thickness tolerance, and

high mechanical stability.

Cells provided with an aqueous alkaline electrolyte as, for example, nickel-cadmium or nickel-hydrogen accumulators and nickel-metal hydride accumulators but also alkaline primary cells, such as alkaline manganese or silver oxide cells, require a separator material which ensures fast absorption of the aqueous alkaline electrolyte, given the increasingly shortened production cycle time.

Disadvantageously, the synthetic fibers used for manufacturing separator material for alkaline cells are hydrophobic by nature as a result of which the important requirement of a fast and good wettability by the electrolyte is not met by them to the required level. However, poor wettability leads to faults in the manufacture of the cells because the proportioned amount of electrolyte cannot be absorbed and distributed in the interior of the cell fast enough. In the case of short cycle times, this leads to insufficient filling of the cells or to contamination of the manufacturing facilities. Moreover, due to the poor wettability, gas bubbles accumulate on and in the separator material during the operation of the energy storage device, the gas bubbles strongly hindering the passage of ions and, consequently, also reducing the performance of the cells. In gas-tight cells, excessive pressure develops which can lead to leakage or even to the bursting of the cell housing.

Various attempts have already been made to improve the wettability, i.e., the hydrophilicity of separator material of intrinsically hydrophobic fibers for use in an electrochemical energy storage device. In this context, U.S. Pat. No. 3,947,537, hereby incorporated by reference herein, describes a treatment of the fiber surfaces with a surface-active agent, a surfactant.

German Patent Application DE-A 25 43 149 proposes to add hydrophilic substances to the polymer melt that is used for spinning fibers or filaments which form the separator.

German Patent Application DE-A 195 23 231 discloses a method for gas-phase fluorination of a separator material. In this context, a small portion of the hydrogen atoms of the polyolefin is substituted by fluorine atoms, as a result of which positively and negatively charged regions are partially generating, producing hydrophilicity. Typical heights of rise of electrolyte of separators that are modified in this manner are in the range of 30 mm/10 min.

Japanese Patent Document JP 55 07 40 57 describes a method for grafting unsaturated, organic acids or acid derivatives onto polyolefins to improve electrolyte adsorption. This method leads to the presence of hydrophilic carboxyl groups, which ensure permanent wettability. In this context, the grafting is accomplished in a wet-chemical manner. As an alternative to this, however, physically induced graftings by UV radiation, beta and gamma radiation as well as corona or plasma treatments are known as well.

In order to generate carboxyl groups in a separator material, Japanese Patent Document JP 06 16 30 21 discloses the use of fibers, which were obtained by copolymerization of acrylonitrile and vinyl chloride, in the blend with polyolefin fibers.

The hydrophilicity of separator material can also be improved by sulfonation. Thus, Japanese Patent Document JP 0 114 62 70 describes the sulfonation of a nonwoven fabric composed of polyolefin fibers. It is true that the sulfonation of separator material effectively reduces the self-discharge of nickel-metal hydride cells, which is why it is widely used for this purpose in spite of its comparatively high price, but the initial wettability of sulfonated products is very low so that complex technical methods, such as vacuum filling, have to be used when filling the batteries. Alternatively, sulfonated separators can also be finished with a wetting agent which, however, has a negative effect on the charge and discharge behavior of the cells.

European Patent Application EP-A 591 616 describes a hydrophilized separator material, which is wetted with 0.5 to 7 percent by weight of deionized water, based on the dry weight of the separator material, prior to its use.

Japanese Patent Document JP 06 18 79 62 describes a separator material for alkaline batteries where the surfaces of the fibers are at least partially coated with an acrylic acid resin.

Finally, Japanese Patent Document JP 08 06 41 93 describes a separator for alkaline batteries, which contains inorganic oxide particles that are colloidallly deposited onto the fibers of the separator material during precipitation from a gel due to their self-binding properties.

### SUMMARY OF THE INVENTION

It is an object of the present invention to specify a hydrophilized separator material which has a very good initial wettability and, consequently, improved hydrophilicity. Another object of the present invention is to provide a method, which allows the hydrophilicity of the separator material to be increased in a simple manner. Ultimately, the present invention also relates to an alkaline cell or battery containing the separator material that is hydrophilized according to the present invention.

The present invention provides a hydrophilized separator material of synthetic fibers and/or filaments (the term “fibers” and “filaments” being used interchangeably and synonomously herein), wherein the separator material is impregnated with 0.01 to 10 g/m² of alkali hydroxide and/or alkali carbonate prior to its use. The separator materials according to the present invention containing 0.01 to 10 g/m² of alkali hydroxide and/or alkali carbonate have an improved initial wettability over comparable separator material that does not contain any alkali hydroxides or alkali carbonates. This manifests itself in increased heights of rise or reduced times to reach the maximum height of rise.

Advantageously, the synthetic fibers and/or filaments are chemical-resistant to strongly alkaline solutions. Because of this, the resistance to failure is increased, in particular in cells or batteries having a long service life.

Particularly preferred is a hydrophilized separator material in which the synthetic fibers and/or filaments exist as a nonwoven fabric. Hydrophilized separator materials according to the present invention, which exist as nonwoven fabric, on one hand, have advantages in terms of cost and, on the other hand, it is possible to ensure high resistance to penetration of the nonwoven fabric by dentrites in spite of the fineness of the fibers.

Also particularly preferred is a hydrophilized separator material, which is additionally hydrophilized prior or subsequent to impregnation by sulfonation, fluorination or grafting with polar substances.

The method according to the present invention for manufacturing a hydrophilized separator material of synthetic fibers and/or filaments is accomplished by impregnating the separator material with an aqueous solution of an alkali hydroxide and/or alkali carbonate and subsequently drying it. This method allows the initial wettability and, consequently, the hydrophilicity of the separator material to be increased in a simple and inexpensive manner.

According to the present invention, the hydroxides and/or carbonates of lithium, sodium and/or potassium are used.

The synthetic fibers and/or filaments that are advantageously used for the manufacture of the separator material are those made of polyolefins, polyamides, polysulfones, polyphenylidene sulfides, polyacetals and/or perfluorinated polyolefins. The aforementioned polymers have proven their worth in terms of their chemical resistance to strongly alkaline solutions as are used in alkaline cells or batteries as electrolyte.

Advantageously, the nonwoven fabric used as separator material is manufactured of a blend of polyamide fibers and/or polyolefin fibers having different softening ranges, the lower-melting fibers being present in a proportion by weight of 30-90%, and laid into a web on a carding machine and, by softening the lower-melting fiber components in an oven and by subsequent gauging to the desired final thickness in a calender under the effect of pressure, and after cooling off, compacted into a nonwoven fabric which is autogenously fused together.

Ultimately, the present invention also relates to alkaline batteries or cells containing a hydrophilized separator material according to the present invention, i.e., a separator material containing a proportion of 0.01-10 g/m² of alkali hydroxide and/or alkali carbonate.

### BRIEF DESCRIPTION OF THE DRAWING

The present invention is explained below with references to examples and to the drawing, in which:

FIG. 1 shows a flow diagram of a method for manufacturing a hydrophilited separator material of synthetic fibers according to the present invention.

### DETAILED DESCRIPTION

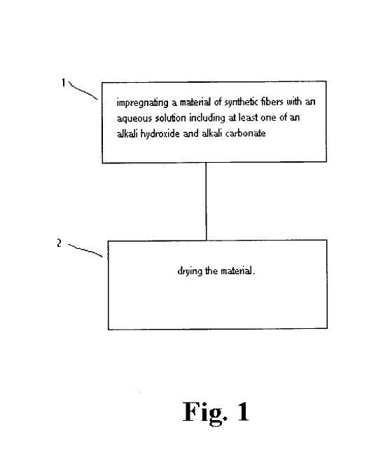

As shown in FIG. 1, a method of manufacturing a hydrophilized separator includes first impregnating a material of synthetic fibers with an aqueous solution including at least one of an alkali hydroxide and an alkali carbonate, in step 1. A solution containing an alkali hydroxide may include, for example, lithium hydroxide, sodium hydroxide and/or potassium hydroxide. A solution including an alkali cabonate may include, for example, lithium carbonate, sodium carbonate and/or potassium carbonate. After the material is impregnated with the aqueous solution, it is subsequently dried in step 2 of FIG. 1. This method allows the initial wettability and, consequently, the hydrophilicity of the separator material to be increased in a simple and inexpensive manner.

### EXAMPLES

DIN-A4 sheets made of different materials were soaked in KOH or K₂CO₃ solutions. Using a padding mangle (p=0.5 Mpa; V=1.5 m/min), a defined wet absorption of the solution was achieved from which the load of KOH or K₂CO₃ per square meter of nonwoven fabric was calculated back (0.01 to 1 g/m²).

For each test, 3 sheets were prepared according to this method. Unfinished, fluorinated and sulfonated nonwoven polyolefin fabrics as well as nonwoven fabrics of polyphenylidene sulfide were used as base materials.

The padding was followed by drying in air at room temperature.

The heights of rise were determined as follows: 2 strips sized 200 mm×20 mm were punched from each of the A4 samples. These strips were clamped in a vertical position and dipped approximately 10 mm into the sample electrolyte (30% KOH) with the end. The height of rise of the electrolyte was visually determined in times of 1, 5 and 10 min. In each instance, untreated samples were used as blind samples.

### Example 1

The heights of rise determined as described above for unfluorinated nonwoven polyolefin fabrics are shown in Table 1.

TABLE 1
heights of rise of 30% KOH solution for an unfluorinated wet nonwoven
polyolefin fabric

| [KOH] | Height of rise | Height of rise | Height of rise |
|---|---|---|---|
| g/m² | (mm/1 min) | (mm/5 min) | (mm/10 min) |
| 0 | 0 | 9 | 19 |
| 0.01 | 8 | 15 | 25 |
| 0.1 | 10 | 33 | 40 |
| 0.5 | 17 | 35 | 53 |
| 1.0 | 24 | 45 | 61 |

### Example 2

The heights of rise determined for fluorinated nonwoven polyolefin fabrics are shown in Table 2.

TABLE 2
heights of rise of 30% KOH solution for a fluorinated wet nonwoven
polyolefin fabric

| [KOH] | Height of rise | Height of rise | Height of rise |
|---|---|---|---|
| g/m² | (mm/1 min) | (mm/5 min) | (mm/10 min) |
| 0 | 3 | 26 | 46 |
| 0.01 | 25 | 50 | 71 |
| 0.1 | 28 | 53 | 75 |
| 0.5 | 28 | 58 | 77 |

### Example 3

Very dry nonwoven fabrics are known to have a strongly reduced wettability. In order to determine the influence of the impregnation with KOH on this behavior, different unfluorinated nonwoven fabrics were dried in a drying oven for 5 hours at 105° C. The determination of the height of rise was carried out immediately after the drying. The values are given in Table 3.

TABLE 3
heights of rise of 30% KOH solution for an unfluorinated wet nonwoven
polyolefin fabric after drying for 5 hours at 105° C.

| [KOH] | Height of rise | Height of rise | Height of rise |
|---|---|---|---|
| g/m² | (mm/1 min) | (mm/5 min) | (mm/10 min) |
| 0 | 0 | 3 | 6 |
| 0.1 | 7 | 18 | 25 |
| 0.5 | 10 | 22 | 30 |

### Example 4

Sulfonated nonwoven polyolefin fabrics have a very poor initial wettability. When impregnated with KOH solution, an extreme improvement of the initial wettability could be found. The values are given in Table 4.

TABLE 4
heights of rise of 30% KOH solution for a sulfonated wet nonwoven
polyolefin fabric

| | | Height | | |
|---|---|---|---|---|
| [KOH] | Height of rise | of rise | Height of rise | Height of rise |
| g/m² | (mm/0.5 min) | (mm/1 min) | (mm/5 min) | (mm/10 min) |
| 0 | 0 | 0 | 0 | 2 |
| 0.1 | 30 | 43 | 80 | 100 |
| 0.5 | 30 | 45 | 80 | 100 |

### Example 5

To show the transferability of the obtained data, test were carried out with a wet nonwoven fabric of polyphenylidene sulfide (PPS). Here too, the wetting properties could be improved (see Table 5).

TABLE 5
heights of rise of 30% KOH solution for a wet nonwoven fabric on the
basis of phenylidene sulfide (PPS)

| [KOH] | Height of rise | Height of rise | Height of rise |
|---|---|---|---|
| g/m² | (mm/1 min) | (mm/5 min) | (mm/10 min) |
| 0 | 0 | 2 | 5 |
| 0.1 | 8 | 15 | 24 |
| 0.5 | 10 | 20 | 25 |

### Example 6

TABLE 6
heights of rise of 30% KOH solution for an unfluorinated wet nonwoven
polyolefin fabric

| [K₂CO₃] | Height of rise | Height of rise | Height of rise |
|---|---|---|---|
| g/m² | (mm/1 min) | (mm/5 min) | (mm/10 min) |
| 0 | 0 | 9 | 19 |
| 0.1 | 5 | 22 | 28 |
| 0.5 | 7 | 26 | 32 |
| 1.0 | 15 | 32 | 38 |

### Example 7

TABLE 7
heights of rise of 30% KOH solution for a fluorinated wet nonwoven
polyolefin fabric

| [K₂CO₃] | Height of rise | Height of rise | Height of rise |
|---|---|---|---|
| g/m² | (mm/1 min) | (mm/5 min) | (mm/10 min) |
| 0 | 3 | 26 | 46 |
| 0.1 | 15 | 26 | 45 |
| 0.5 | 18 | 24 | 45 |
| 1.0 | 20 | 38 | 43 |

### Example 8

TABLE 8
heights of rise of 30% KOH solution for a sulfonated wet nonwoven
polyolefin fabric

| | | Height | Height | |
|---|---|---|---|---|
| [K₂CO₃] | Height of rise | of rise | of rise | Height of rise |
| g/m² | (mm/0.5 min) | (mm/1 min) | (mm/5 min) | (mm/10 min) |
| 0 | 0 | 0 | 0 | 2 |
| 0.1 | 22 | 29 | 62 | 80 |
| 0.5 | 22 | 31 | 65 | 83 |
| 1.0 | 25 | 34 | 67 | 85 |

The impregnation tests shows a clear improvement of the wettability for all tested materials. The very significant improvement of the wettability of the sulfonated polyolefins is particularly remarkable.

The effect of an impregnation with KOH is somewhat better than that produced by impregnation with K₂CO₃.

By impregnation, it is possible to achieve an acceptable initial wettability of very dry materials.

Even small concentrations of impregnated substance on the nonwoven fabric (10 mg/m²) lead to a significant improvement of the wettability.

Estimation of the Influence of the Impregnated Separator on the KOH Concentration in the Electrolyte

In principle, the KOH concentration of the electrolyte could be influenced (increased) by the KOH impregnated separator. Assuming a separator area of 50 cm² and an amount of electrolyte of 30% KOH of 2 g, the KOH concentration of the electrolyte would increase by around 10 ppm, given a KOH load of the separator of 1 g/m². This potential increase is to be classified as negligible.

Estimation of a Possibly Detrimental Effect by Arising or Deposited Potassium Carbonate

In a humid environment, solid potassium hydroxide can react in the presence of carbon dioxide, forming potassium carbonate. The rate of this reaction is influenced, inter alia, by a) the partial pressure of the C0₂, b) the air humidity, and c) the particle size of the deposited potassium hydroxide. Assuming a complete conversion of the KOH to K₂CO₃ according to

2KOH+CO₂+H₂O->K₂CO₃+2H₂O

a KOH load of 1.00 g/m² would result in a K₂CO₃ load of 1.21 g/m². Assuming that this carbonate quantity is dissolved by the electrolyte, the resulting CO₃²⁻ concentration would assume a value of 1.3 ppm (given the values for the separator area and the electrolyte volume assumed above). This carbonate concentration is not to be regarded as critical; the typical carbonate concentrations caused by CO₂ absorption of the electrolyte during the filling, are about 2 magnitudes higher.

In order to determine the CO₂ absorption from air and the resulting formation of carbonate on the surface of the nonwoven fabrics manufactured in this manner, sheets were exposed for 7 days to a pure C0₂ atmosphere at a pressure of 0.5 MPa and room temperature. The reduction in the OH⁻ concentration prior and subsequent to the exposure was titrimetrically determined against 0.1 n HCl. After this exposure, approximately 15% of the originally present hydroxide had been converted to carbonate.

Correspondingly low concentrations of free carbonate in the battery electrolyte apply to an impregnation with K₂CO₃. Here, the concentrations to be expected lie at 1 ppm maximum and, consequently, far below the critical values.

What is claimed is:

1. A hydrophilized separator, comprising:
a material including synthetic fibers; and
an alkali compound including at least one of an alkali hydroxide and an alkali carbonate, wherein the alkali compound is present in an amount of 0.01 to 10 g/m².

2. The hydrophilize separator as recited in claim 1, wherein the alkali compound impregnates the material.

3. The hydrophilized separator as recited in claim 1, wherein the synthetic fibers are chemically resistant to strongly alkaline solutions.

4. The hydrophilized separator as recited in claim 1, wherein the material includes a nonwoven fabric of the synthetic fibers.

5. The hydrophilized separator as recited in claim 2, wherein the material is further impregnated by at least one of sulfonation and fluorination.

6. The hydrophilized separator as recited in claim 2, further comprising polar substances grafted to the material.

7. The hydrophilized separator material as recited in claim 1, wherein the synthetic fibers include a polymer selected from the group consisting of polyolefins, polyamides, polysulfones, polyphenylidene sulfides, polyacetals and perfluorinated polyolefins.

8. The hydrophilized separator material as recited in claim 1, wherein the alkali compound includes at least one of lithium hydroxide, sodium hydroxide and potassium hydroxide.

9. The hydrophilized separator material as recited in claim 1, wherein the alkali compound includes at least one of lithium carbonate, sodium carbonate and potassium carbonate.

10. A method for manufacturing a hydrophilized separator, comprising:
impregnating a material of synthetic fibers with an aqueous solution including at least one of alkali hydroxide and alkali carbonate; and
drying the material.

11. The method as recited in claim 10, wherein the solution includes at least one of lithium hydroxide, sodium hydroxide and potassium hydroxide.

12. The method as recited in claim 10, wherein the solution includes at least one of lithium carbonate, sodium carbonate and potassium carbonate.

13. The method as recited in claim 10, wherein the synthetic fibers include a polymer selected from the group consisting of polyolefins, polyamides, polysulfones, polyphenylidene sulfides, polyacetals and perfluorinated polyolefins.

14. The method as recited in claim 10, further comprising processing the synthetic fibers into a nonwoven fabric, and wherein the material includes the nonwoven fabric.

15. The method as recited in claim 10, further comprising processing the synthetic fibers into a woven fabric and wherein the material includes the woven fabric.

16. The method as recited in claim 10, further comprising further impregnating the synthetic fibers by at least one of sulfonation and fluorination.

17. The method as recited in claim 10, further comprising further impregnating the synthetic fibers by grafting the fibers with polar substances.

18. The method as recited in claim 14, wherein the fibers include a blend of at least one of polyamide fibers and polyolefin fibers, the blend including lower-melting fibers in a proportion by weight of 30-90% and higher-melting fibers, the method further comprising:
laying the lower-melting fibers into a web on a carding machine;
softening only the lower-melting fiber components in an oven;
gauging the lower-melting fibers to a desired final thickness using pressure;
cooling the lower melting fibers;
compacting and autogenously fusing the fibers together into the nonwoven fabric.

19. An alkaline battery cell, comprising:
a hydrophilized separator that includes a material of synthetic fibers and an alkali compound including at least one of an alkali hydroxide and an alkali carbonate, the alkaline compound being present in an amount of 0.01 to 10 g/m².

20. The alkaline battery cell as recited in claim 19 further comprising a positive electrode and a negative electrode, the positive and negative electrodes being separated by the separator material.
